(19) United States
(12) Patent Application Publication
(10) Pub. No.: US 2008/0104882 A1
(43) Pub. Date: May 8, 2008

(54) Insect bait station

(76) Inventors: Alan S. Bernard, Boca Raton, FL (US); Michael M. Anthony, Coral Springs, FL (US)

Correspondence Address: Mark D. Bowen;Stearns Weaver Miller, et al., Suite 2100, 200 East Las Olas Boulevard, Fort Lauderdale, FL, 33301, US

(21) Appl. No.: 12/004,691

(22) Filed: Dec. 21, 2007

Related U.S. Application Data
(63) Continuation-in-part of application No. 11/093,200, filed on Mar. 29, 2005, now Pat. No. 7,310,908.
Application No. 11/093,200 is a continuation-in-part of application No. 10/679,828, filed on Oct. 6, 2003, now Pat. No. 6,871,444.

(51) Int. Cl. A01M 1/20

(52) U.S. Cl. 43/131

(57) ABSTRACT

An insect bait station, for use with a flowable insect bait, is designed for secure anchorage to the ground, and is capable of being deployed either alone or with other bait stations in various stacked configurations is disclosed. A generally hollow main body defines an internal reservoir for containing a flowable, preferably liquid, bait contained therein. A generally planar base is adapted for receiving a ground anchor removably connected thereto to facilitate anchoring the station to the ground. Insects are guided to the an access opening in the top of the bait station by a plurality of recessed channels that originate in proximity to the bottom and run along the bait station body to an access opening in the top portion thereof. A removable cover is provided for attachment to the bait station and includes a downwardly depending ramp that is received within the access opening to provide insects with an ingress and egress path down to the bait contained within the housing. The cover includes a top surface having an upwardly projecting connection structure to allow for connection of the cover of a first bait station to the bottom of a second bait station thereby allowing a plurality of bait stations to be deployed in a connected stacked configuration. An alternate embodiment includes a top end adapted with a hook-shaped portion to allow the bait station body to be hung from a supporting structure, and a bottom end adapted for securely mounting the bait station to the ground.

### CROSS REFERENCE TO RELATED APPLICATIONS

This application is a Continuation-In-Part of U.S. patent application Ser. No. 11/093,200, filed on Mar. 29, 2005, which is a Continuation-In-Part of U.S. patent application Ser. No. 10/679,828, filed Oct. 6, 2003, now U.S. Pat. No. 6,871,444, each of which are incorporated hereby by reference.

### STATEMENT REGARDING FEDERALLY SPONSORED RESEARCH OR DEVELOPMENT

Not Applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights.

### BACKGROUND OF THE INVENTION

1. Field of the Invention

The present invention relates to devices for use in exterminating pests, and more particularly to a modular insect bait station that holds a liquid, gel, or granular insecticide or pesticide. In a first embodiment, a blow molded modular re-fillable bait station is disclosed. The bait station is adapted for connection to other modular bait stations in a stacked configuration. In a second embodiment, a blow molded pre-filled bait station is disclosed.

2. Description of the Background Art

Human populations have long encountered problems co-existing with various insects, particularly ants. There are more than ten thousand species of ants, a number of which infest structures, lawns, parks, and other areas frequented by humans, as well as agriculture and crops. The various species of ants vary widely in many respects including size, color, shape, distribution, food preference, and nest locations. Many other species of ants routinely disrupt activities in homes, offices, parks, and protect homopteran pests that can impact agriculture crops and ornamental plantings. As a result, controlling insect populations is therefore necessary.

A primary means of pest control involves the use of toxicants, particularly liquid poison. The spraying of liquid poison is a common method of pest control. Spraying liquid poison, however, involves a number of inherent disadvantages. A primary disadvantage involves the risk of exposing humans to the toxic chemical formulations. Furthermore, spraying poison is often harmful to the environment and often causes damage to vegetation and other animal species in addition to the targeted pest population. In addition, liquid poison that has been applied by spraying often degrades over time and/or is washed away by rain or irrigation water thereby reducing effectiveness and requiring repeated treatment and/or the use of greater quantities. Toxicants can also leach into the soil and end up contaminating the ground water.

For these and other reasons it has been found preferable to contain liquid or gel toxicants in bait stations, which stations provide structures that contain the poison while providing access to insects.

The background art reveals a number of attempts directed to pest control. The following patents provide examples of these attempts.

| | |
|---|---|
| 4,648,201 | Sherman |
| 4,782,621 | Wissman |
| 4,793,093 | Gentile |
| 4,823,506 | Demarest et al. |
| 4,841,669 | Demarest et al. |
| 5,446,992 | Stewart |
| 5,501,033 | Wefler |
| 5,775,026 | Pearce et al. |
| 5,802,761 | Demarest et al. |
| 5,875,586 | Ballard et al. |
| 5,943,816 | Hyatt et al. |
| 5,943,817 | Miller |
| 5,953,854 | Hyatt |
| 5,983,558 | Las et al. |
| 6,041,542 | Payton et al. |
| 6,189,259 | Soller |
| 6,195,933 | Woodruff |
| 6,216,384 | Dickson et al. |
| 6,532,696 | Clark III, et al. |

U.S. Pat. No. 4,793,093, issued to Gentile, discloses a feeding station for vermin that allows for ingress of the vermin to feed on poisoned bait held at a central portion therein. The bait is contained within a central well and ingress is facilitated by an inclined ramp leading to the chamber. A cover is joined to the top of the base member to cover the central well holding the poisoned bait.

U.S. Pat. Nos. 4,823,506 and 4,841,669, issued to Demarest et al., each disclose an insect bait device for exterminating crawling insects. The devices comprise first and second housing portions joinable to form a housing that defines generally unobstructed entry into the device by an insect. U.S. Pat. No. 5,802,761, also issued to Demarest et al., discloses a bait station including a base defining a bait-cup and a cover fastened to the base. The cover and base cooperate to form a door and walkway to admit targeted insects to enter the bait station thus gaining access to the bait cup.

U.S. Pat. No. 5,501,033, issued to Wefler, discloses a liquid delivery bait station having two reservoirs and fluid transfer systems to allow sequential delivery of two liquids. The liquids are preferably an insect attractant that is first delivered into an absorbent feeding pad and an insect toxicant that is next delivered to the absorbent pad.

U.S. Pat. No. 5,775,026, issued to Pearce et al., discloses an insect bait station for attracting and killing insects that comprises a substantially flat configuration with insecticide formulated as a solid coating on the surface of a sheet of moisture free material, and one or more breakable ampoules containing an attractant composition. The ampoules are held in a compressible portion of the housing permitting them to be manually broken to discharge their contents on command thereby releasing attractant vapors.

U.S. Pat. No. 5,875,586, issued to Ballard et al., discloses a refillable liquid bait station formed to allow access by insects, but not by larger animals. The bait station includes a transparent housing that protects the liquid bait from wind and rain and which further prevents leakage if the bait station is tumbled and/or placed in an incorrect position by use of a series of inner walls and chambers.

U.S. Pat. No. 5,943,816, issued to Hyatt et al., discloses an insect bait station for delivering a liquid toxicant. The bait station includes a reservoir, a feeding disk with capillary feeding pores, and a base that seals the feeding pores when configured in a closed position. U.S. Pat. No. 5,953,854, also issued to Hyatt, discloses a spill resistant granular bait station having a tunnel entrance leading to an interior bridged member having an inner wall leading from the bottom surface to an inner surface having an access opening in the bridge member leading to a bait source contained within the station. A cover defines a recessed portion thereon closely cooperating with the access opening in the base.

U.S. Pat. No. 6,041,542, issued to Payton et al., discloses a spill-resistant liquid bait station for dispensing liquid bait. The liquid bait is contained in a reservoir at the bottom of the bait station base and a lid is secured over the end of the base. The interior of the bait station is configured for containing the liquid bait if the bait station is inverted. Insects enter the bait station through one or more access ports and then travel through an interior passageway to the liquid bait.

U.S. Pat. No. 6,189,259, issued to Soller, discloses an insect bait-and-switch liquid delivery apparatus for the control of insects. The apparatus includes a reservoir defining a first chamber containing a liquid attractant and a second chamber containing a liquid toxicant. A first feeding station is provided in the first chamber and a second feeding station is provided in the second chamber. A passageway connects the first and second chambers, and an access port is disposed to initially prevent or limit access of an insect to the second feeding station during an initial feeding period and the subsequently enable access to the second feeding station via the passageway after the initial feeding period.

U.S. Pat. No. 6,195,933, issued to Woodruff, discloses a bait station for delivery of liquid insecticide formed from a base having at least one feeding station and a reservoir for storing liquid beneath the base. The insecticide is transferred by capillary action from the reservoir to the feeding station via a connecting tube.

U.S. Pat. No. 6,216,384, issued to Dickson et al., discloses an insect bait station having a continuous outer wall leading from a base to an upper annular surface having a central axial recessed opening therein leading down to a bait source contained in the interior of the station. The interior of the station defines an inverted conical concave part for concentrating the bait to the lowest point of the cone in proximity with an opening in the bottom of the central axial recessed opening.

U.S. Pat. No. 6,532,696, issued to Clark III, et al., discloses a holder for liquid insect bait comprising a sealed container having a bottom portion defining contours that form reservoirs and channels wherein liquid bait may be located and flow. The device is deployed by orienting the device in a vertical configuration whereby the liquid bait flows to specified internal reservoirs, cutting an entrance opening in the container at a specified location, and placing the container in a horizontal configuration wherein the liquid bait flows to additional reservoirs accessible to the insects.

The present inventor has contributed significant advancements in the art of insecticide delivery using insect bait stations. In U.S. Pat. No. 6,871,444, the present inventor discloses a user activated, disposable insect bait station particularly adapted for use with liquid bait, including attractants and toxicants. The bait station is formed as a sealed container fabricated from two primary parts, an upper half and a lower half sealingly connected along common peripheral edges. The bait station includes first and second internal chambers. The first internal chamber contains a liquid bait reservoir wherein all of the liquid bait is stored prior to use, and the second internal chamber is adapted to function as an entrance providing insects access to the second chamber. Manual manipulation of the bait station is required for activation whereby a frangible seal is broken placing the first and second chambers in fluid communication thereby allowing liquid bait to flow into the second chamber. Further advancements relating to the bait station are disclosed in pending Ser. No. 11/093,200.

While the insect bait stations disclosed in the art are generally suitable for the purposes for which they are intended, there exists a need for an improved insect bait station that is designed for secure anchorage to the ground, capable of being deployed either alone or with other bait stations in various stacked configurations, and further adapted with a fill port to re-filling.

### BRIEF SUMMARY OF THE INVENTION

The present invention provides, in a first embodiment, an insect bait station, particularly adapted for use with liquid insecticides and pesticides which is designed for secure anchorage to the ground, and is capable of being deployed either alone or with other bait stations in various stacked configurations, and further adapted with a fill port to re-filling. A bait station in accordance with the first embodiment comprises a generally hollow main body defining an internal reservoir for containing a flowable, preferably liquid, bait contained therein. The main body is preferably fabricated from plastic via a blow molding process, and may pre-filled, user filled, and is also re-fillable. A generally planar base is adapted for receiving a ground anchor removably connected thereto to facilitate anchoring the station to the ground. Insects are guided to the an access opening in the top of the bait station by a plurality of recessed channels that originate in proximity to the bottom and run along the bait station body to an access opening in the top portion thereof. The main body further defines an openable fill port to allow for re-filling of the bait station. A removable cover is provided for attachment to the bait station and includes a downwardly depending ramp that is received within the access opening to provide insects with an ingress and egress path to the bait contained within the housing. The cover includes a top surface having an upwardly projecting connection structure to allow for connection of the cover of a first bait station to the bottom of a second bait station thereby allowing a plurality of bait stations to be deployed in a connected stacked configuration.

In an alternate embodiment, a blow molded, pre-filled bait station is provided. In accordance with the alternate embodiment, a blow molded bait station body comprises a main body portion having a top end and a bottom end. The main body defines an internal volume for containing a flowable, preferably liquid bait (e.g. combination of attractant and toxicant). The top end is preferably curved or hook-shaped to allow the bait station body to be hung from a supporting structure, such as a tree or beam, and terminates in a tear/twist off end tab that is removed by the user upon activation to provide insect access to the bait contained in the main body. The bottom end preferably defines a ground spike to allow the bait station to be securely mounted to the ground.

Accordingly, it is an object of the present invention to provide an improved insect bait station.

Still another object of the present invention is to provide an insect bait station specifically adapted to be anchored to the ground when deployed.

Another object of the present invention is to provide an insect bait station having a cover that shields an access opening from the wind thereby minimizing evaporation loss.

Still further objects and advantages will become apparent from a consideration of the ensuing description and drawings.

### BRIEF DESCRIPTION OF THE SEVERAL VIEWS OF THE DRAWINGS

FIG. 1 is a top perspective view of an insect bait station assembly including the main bait station body, cover, and ground anchor in accordance with the present invention;

FIG. 2 is bottom perspective view thereof;

FIG. 3 is an exploded side perspective view thereof;

FIG. 4 is a top perspective view of the bait station main body;

FIG. 5 is a sectional view thereof;

FIG. 6 is a top perspective view of the bait station cover;

FIG. 7 is a bottom perspective view thereof;

FIG. 8 is a perspective view of a ground anchor for use with the present invention;

FIG. 9 is a bottom perspective view of the bait station assembly;

FIG. 10 is a side view thereof;

FIG. 11 is a perspective partially exploded sectional view of two bait stations configured in stacked relation;

FIG. 12 is a top perspective view thereof;

FIG. 13 is a side view of an alternate embodiment bait station in accordance with the present invention; and

FIG. 14 is a side sectional view thereof.

### DETAILED DESCRIPTION OF THE INVENTION

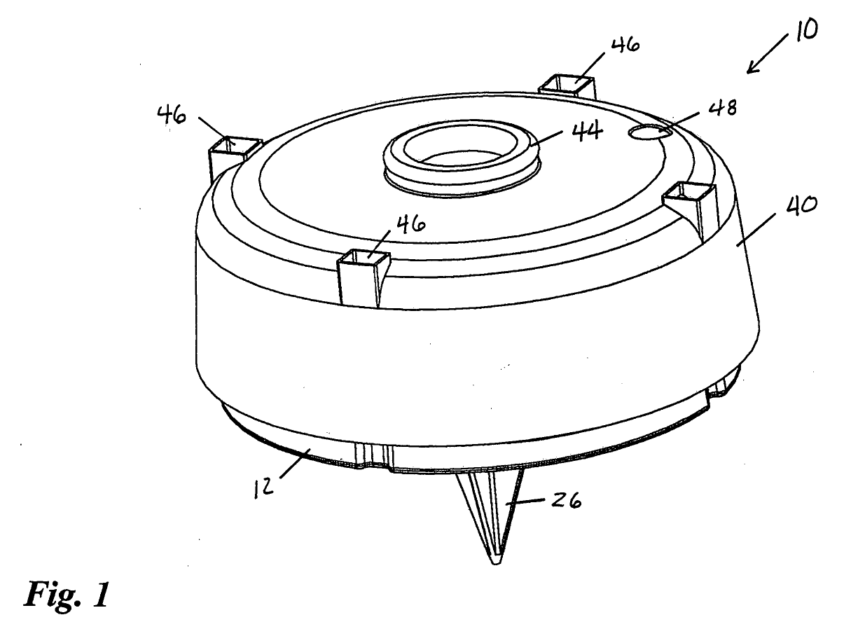

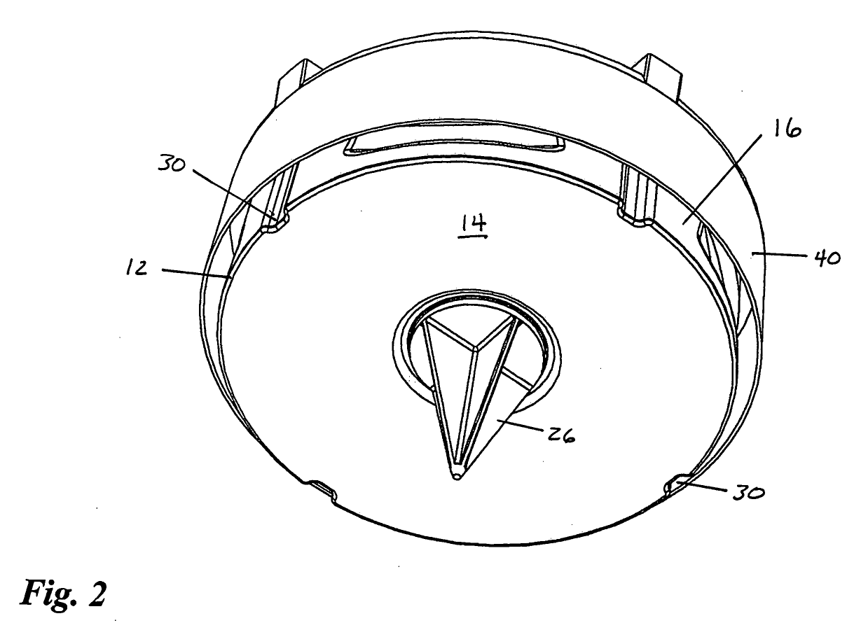

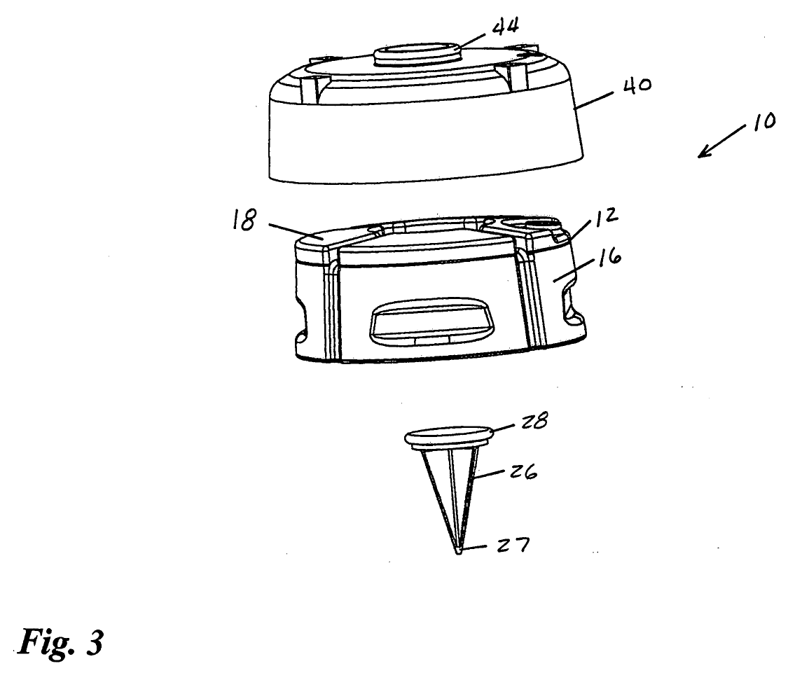

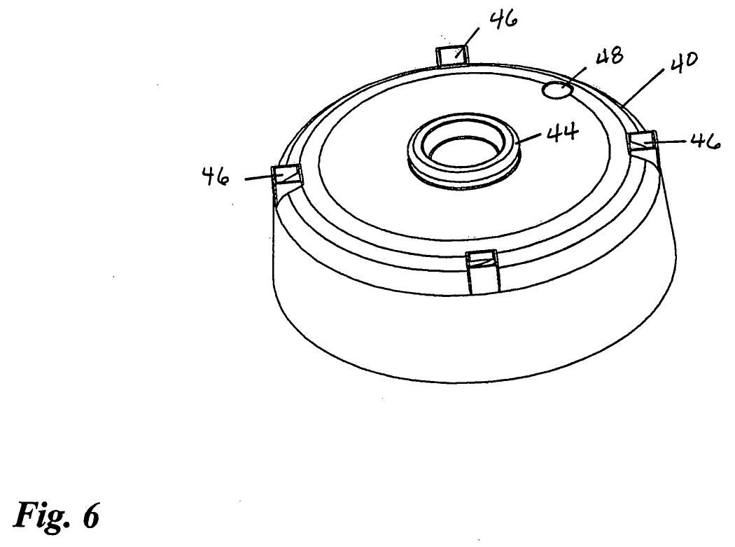

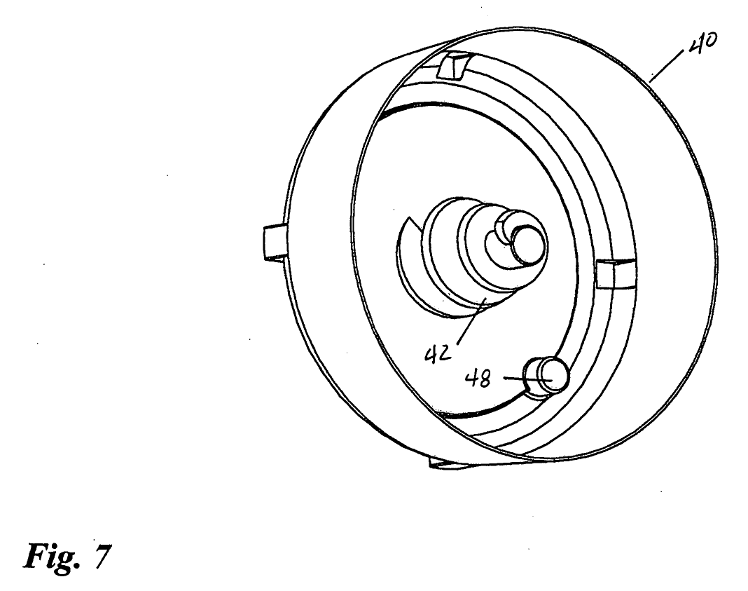

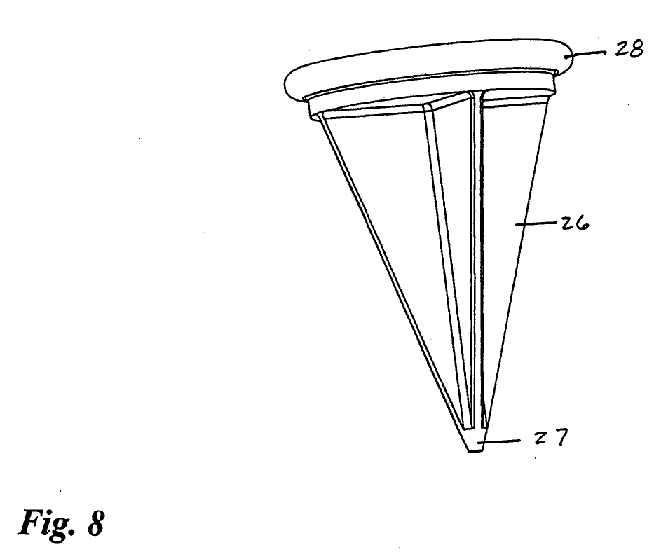

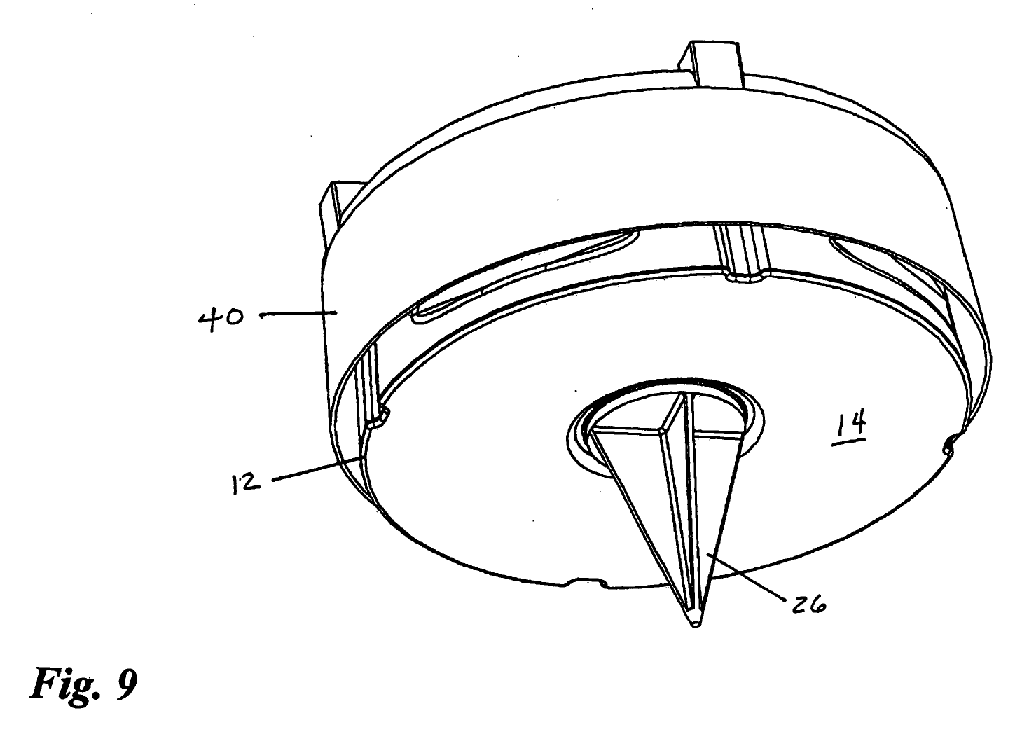

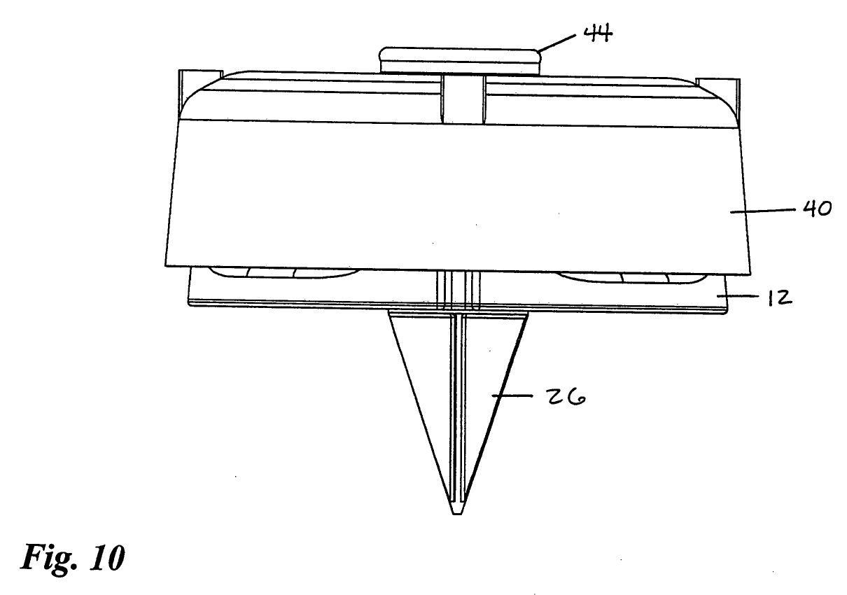

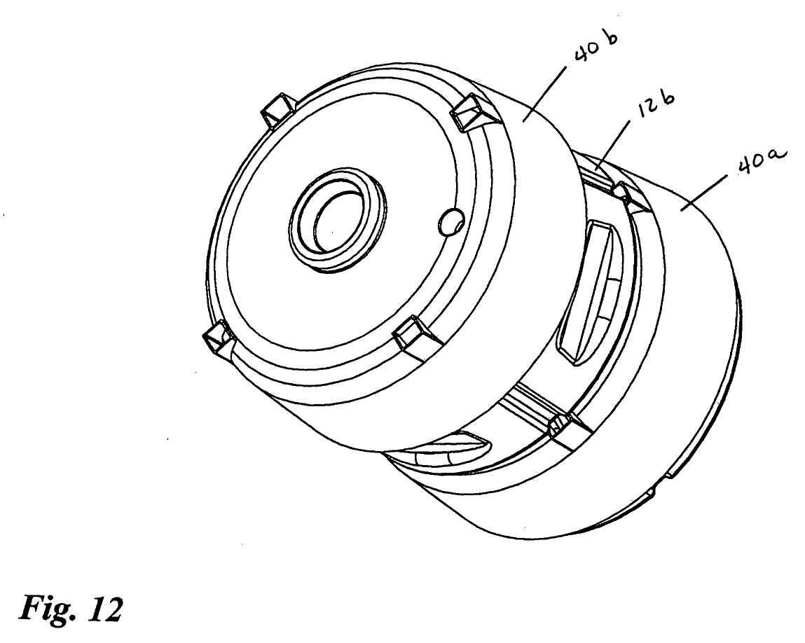

With reference to the drawings, FIGS. 1-12 depict a refillable insect bait station, generally referenced as 10, in accordance with a preferred embodiment of the present invention. Insect bait station comprises a main body 12 defining an internal reservoir 13 for containing a flowable bait (not shown), such as a toxicant combined with an attractant. As best seen in FIGS. 2 and 3, main body 12 is preferably generally disc-shaped and includes a generally planar bottom 14, a generally cylindrical sidewall 16 extending upward from bottom 14, and a top 18 defining an axially disposed opening 20 defined by a downwardly depending circumferential wall 22 terminating at on open bottom end in close proximity to bottom 14 for providing access to the flowable bait contained within the internal reservoir. It should be noted, however, that bait station body 10 may be any suitable shape, such as square, cube, cylinder, or any other geometric shape or combination of shapes. A significant aspect of the present invention relates to providing a relatively large internal reservoir having a relatively small access opening thereby exposing only a small surface area of the flowable bait to the atmosphere so as to minimize evaporative loss over time. The access opening is disposed above the level of fluid in the container and opens to provide access to a downwardly depending tubular wall 22 terminating in close proximity to bottom 14. Entry into the container is through the opening above the level of the liquid and into tubular wall 22 that protrudes downward into a main chamber to form a secondary chamber in direct fluid communication with the main chamber. Forming a secondary chamber provides two important advantages. First, a certain number of insects will fall into the liquid bait and drown. By having a smaller inner chamber the number of insects that fall into the bait are reduced. Dead insects can give off a warning chemical upon their death making the bait unattractive. Thus, reducing the number of dead insects in contact with bait material is advantageous. The second reason is that direct communication of the bait between the two chambers in the activated state is important is because most liquid insect baits contain sugar and when these baits are exposed to the environment they can experience a loss of water and tend to crystallize which renders them unattractive to insects. Since the bait material in the two chambers keeps the water, sugars, and other materials at equal levels in both chambers preventing crystallization and thereby keeping the bait material attractive for an extended period of time. In the preferred configuration the secondary chamber extends nearly to the base of the main chamber, so that if the station is inverted or tilted to a 90 degree angle the amount of fluid that can be spilled is reduced. Accordingly, this structure contains substantially all of the flowable bait within the internal reservoir should the bait station become inverted. Main body 12 is preferably fabricated from a suitable plastic material and may be formed by a suitable molding technique, such as blow molding.

The bottom 14 of main body 12 is preferably adapted with a connection port 24 for facilitating connection of additional structure to main body 12. In a preferred embodiment, connection port 24 preferably comprises a generally cylindrical recessed portion adapted to receive the top portion of a ground anchor 26, or other structure as disclosed herein, in snap-fit/press-fit engagement with the main body bottom portion to facilitate anchoring of the main body to the ground. In a preferred embodiment, ground anchor 26 comprises an elongate spike having a pointed/ground piercing tip 27, and a generally cylindrical top 28 sized for mating snap fit engagement with connection port 24 on the bottom 14 of main body 12 as best seen in FIG. 2.

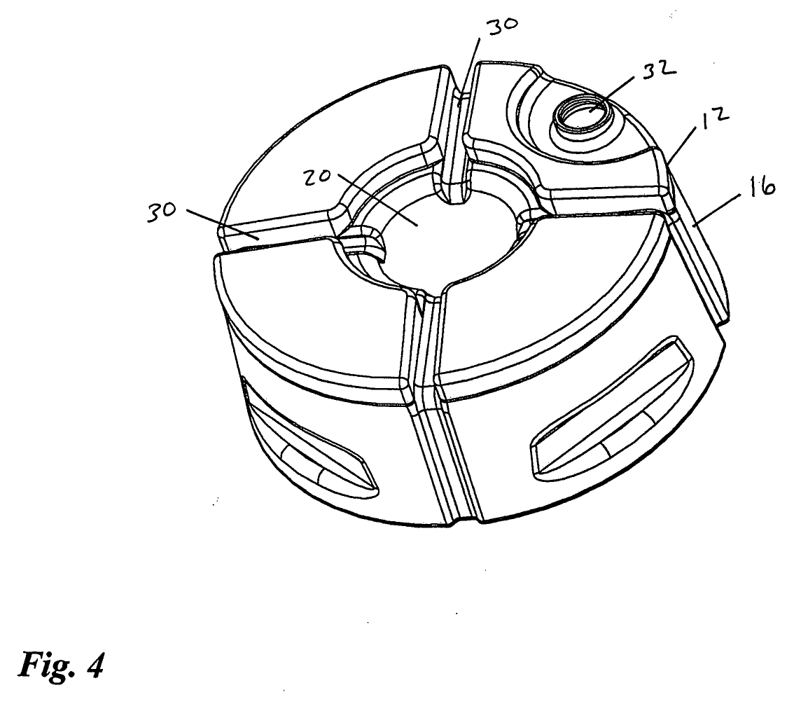

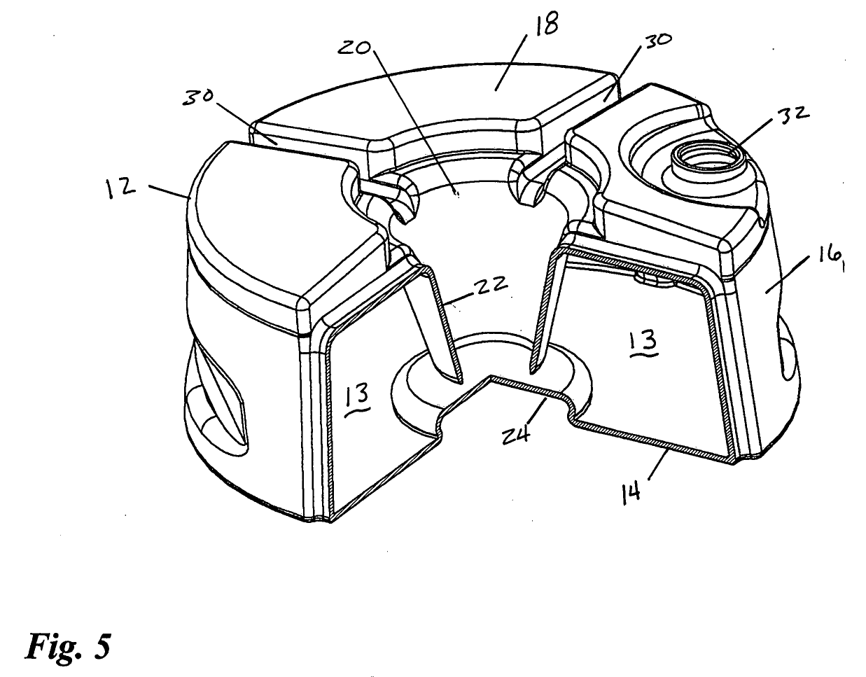

The sidewall 16 an top 18 are preferably adapted to define a plurality of recessed grooves or channels, referenced as 30, running from the intersection of the sidewall 16 and bottom 14 upward to the sidewall top 18 and radially across the top to the axially disposed top opening 20. Channels 30 function to provide defined ingress/egress paths to guide insects directly to opening 20 for access to the bait contained within the internal bait reservoir. As seen in FIGS. 4 and 5, the top 18 of main body 12 further includes a fill port 32 in fluid communication with internal reservoir 13 to allow for the re-filling of the bait station. Fill port 32 is preferably disposed in proximity to the outer circumferential edge of top 18 as seen in FIG. 4, however, any suitable location is considered within the scope of the present invention.

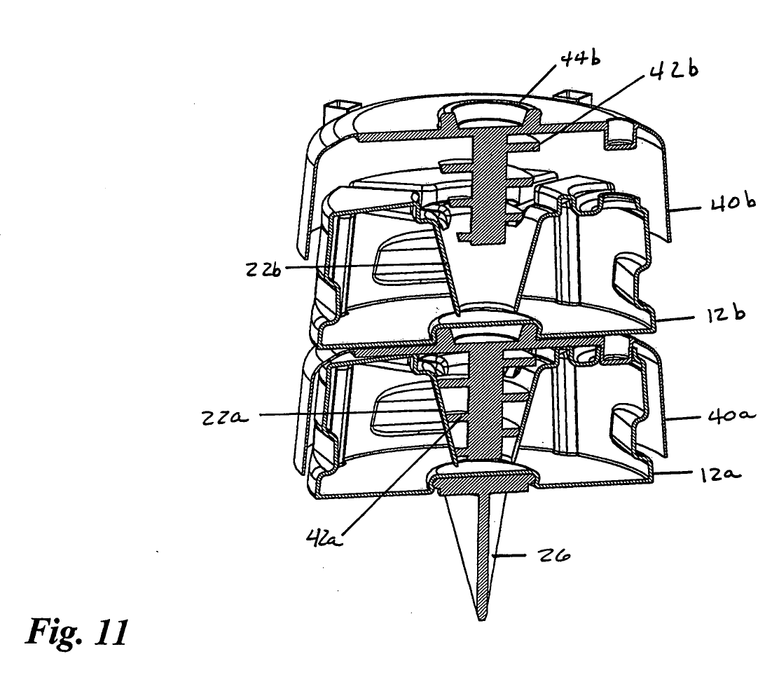

A removable, dome-shaped cover 40 is provided for removable attachment to main body 12 in covering relation therewith as seen in FIGS. 1 and 2, and in exploded relation therewith in FIG. 3. Cover 40 functions to shield the main body, and particularly opening 20 from the elements of sun, wind, rain, etc. Cover 40 may be secured to main body 12 by any suitable press-fit or snap-fit configuration. Cover 40 not only minimizes evaporative loss of liquid bait, but further prevents contamination of the bait by preventing debris or rain from entering the station through opening 20 and contaminating the or diluting the bait. Cover 40 includes an undersurface having a downwardly projecting spiral ramp 42 that functions to provide a helical ingress and egress ramp down through the axially disposed main body opening to the flowable bait contained in the main body reservoir when disposed in mating relation therewith as seen in FIG. 11. Cover 40 further includes a top surface defining a cylindrical, upwardly projecting connecting lug 44 sized for mating engagement with the correspondingly sized cylindrical recessed portion of connection port 24 formed on the bottom 14 of the main body 12 of an additional bait station to allow for connection of bait stations in a vertically stacked configuration as more fully discussed below. Cover 40 is further adapted with pass through openings 46 to allow insects to pass between adjacent stations in a vertically stacked configuration. Finally, cover 40 may define a plug 48 intended for alignment and inserted sealing engagement with fill port 32 on bait station body 12 to seal the fill port while locking the cover in place.

FIGS. 1 and 3 illustrate assembly of an insect bait station assembly 10 in accordance with the present invention. More particularly, once the bait station main body 12 is filled with a flowable bait using fill port 32, a cover 40 is placed in covering relation with the bait station and secured by press fit. In applications wherein the bait station will be deployed on the ground, a ground anchor 26 may be affixed to the bottom 14 by snap-fit engagement of ground anchor cap 28 within recessed portion 24. When deployed on the ground, ground anchor 26 functions to secure the bait station by penetrating the ground. As noted above, the present invention contemplates deployment of a plurality of connected bait stations. More particularly, FIG. 11 illustrates a first bait station body, referenced as 12a, having a cover 40a, attached thereto, and a ground anchor 26 connected to the bottom thereof. A second bait station body, referenced as 12b, is connected to the first bait station by direct attachment to cover 40a thereby providing a stacked assembly consisting of first and second bait stations.

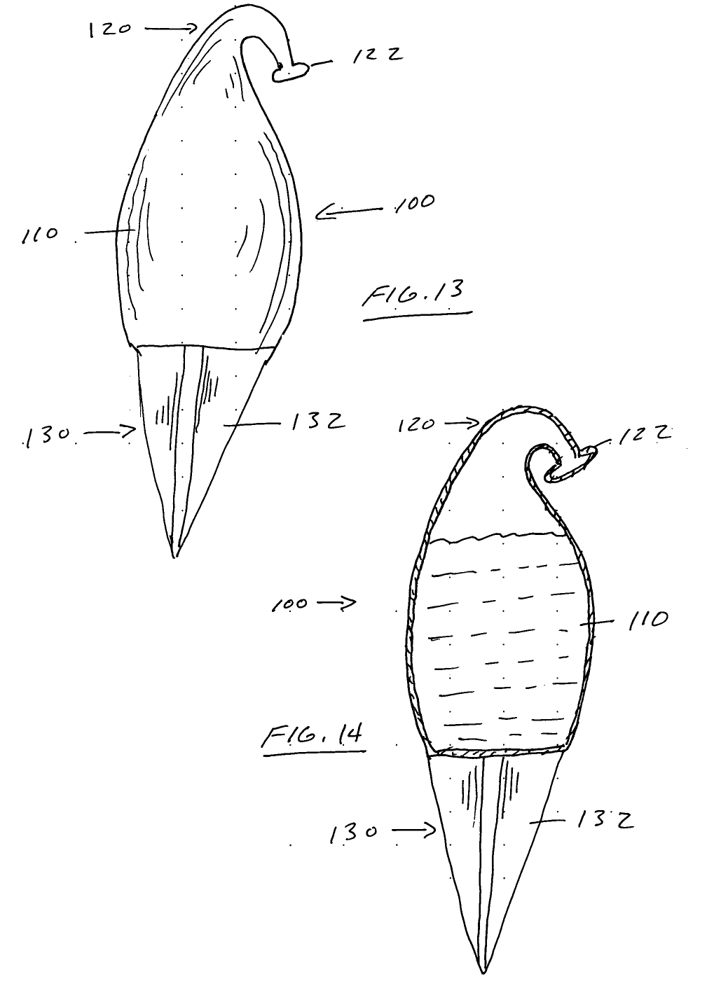

FIGS. 13 and 14 depict an alternate embodiment blow molded bait station, generally referenced as 100. Bait station 100 comprises a bait station structure preferably fabricated by blow molding wherein the bait station is pre-filled and sealed as part of the blow molding fabrication process. Bait station 100 includes a main body portion 110 having a top end 120 and a bottom end 130. The main body defines an internal volume for containing a flowable, preferably liquid, bait (e.g. combination of attractant and toxicant) which is preferably injected into the bait station as part of the manufacturing process. Top end 120 is preferably curved or hook-shaped to allow the bait station body to be hung from a supporting structure, such as a tree or beam. Top end 120 terminates in a frangible (e.g. tear-off/twist-off) end tab 122 that may be removed by the user upon activation to provide insect access to the bait contained in the main body. Bottom end 130 is preferably adapted with a projecting ground spike 132 that allows the bait station to be securely mounted to the ground. Ground spike 132 may be formed as an integral part of the blow molded bait station, or alternatively may be removably connected as disclosed hereinabove.

The instant invention has been shown and described herein in what is considered to be the most practical and preferred embodiment. It is recognized, however, that departures may be made therefrom within the scope of the invention and that obvious structural and/or functional modifications will occur to a person skilled in the art.

What I claim is:

1. An insect bait station comprising:
a bait station body including a base, a top, and a side wall connecting said base and top, said body defining an internal bait reservoir;
said base including means for anchoring said bait station body to the ground; said top including an opening for providing insects with access to said internal bait reservoir;
said side wall and said top defining at least one channel having a first end disposed in proximity with said base and a second end disposed in proximity with said top opening.

2. An insect bait station according to claim 1, wherein said means for anchoring said bait station body to the ground comprises a ground anchor removably connected to said base.

3. An insect bait station according to claim 1, further including a top cover connectable to said bait station body in covering relation with said top.

4. An insect bait station according to claim 3, wherein said top cover includes a downwardly projecting spiral ramp.

5. An insect bait station according to claim 3, wherein said top cover includes an upwardly projecting connecting lug sized for mating engagement with said connection port to allow a first bait station and cover assembly to be connected to a second bait station and cover assembly in stacked relation.

6. An insect bait station comprising:
a bait station body including a base, a top, and a side wall connecting said base and top, said body defining an internal bait reservoir;
said base including means for connecting an auxiliary component to said body;
said top including an opening for providing insects with access to said internal bait reservoir, said opening defined by a downwardly depending circumferential wall terminating at on open bottom end in close proximity to said base;
said side wall and said top defining at least one channel having a first end disposed in proximity with said base and a second end disposed in proximity with said top opening;
a cover removably connectable to said bait station body in covering relation with said top, said cover including a downwardly projecting spiral ramp, said ramp axially disposed relative with said circumferential wall when said cover is connected to said bait station.

7. An insect bait station according to claim 6, further including a ground anchor adapted for connection to said base via said means for connecting an auxiliary component.

8. An insect bait station according to claim 6, wherein said cover further defines at least one pass through.

9. An insect bait station comprising:
a main body having a top end and a bottom end;
said main body defining an internal volume for containing a flowable bait;
said top end including a portion thereof defining a hook-shape, and terminating in a frangible end tab, whereby removal of said end tap forms an opening for providing insects access to the bait contained within said internal volume;
said bottom end including means for anchoring the bait station to the ground.

10. An insect bait station according to claim 9, wherein said means for anchoring the bait station to the ground comprises a ground anchor.
